(19) United States
(12) Patent Application Publication
(10) Pub. No.: US 2026/0298363 A1
(43) Pub. Date: Oct. 1, 2026

(54) ACTUATOR FOR AUTOMATION TECHNOLOGY

(71) Applicant: AUMA Riester GmbH & Co. KG, Müllheim (DE)

(72) Inventor: Rudolf MORLANG, Villingen-Schwenningen (DE)

(73) Assignee: AUMA Riester GmbH & Co.KG, Müllheim (DE)

(21) Appl. No.: 19/477,919

(22) PCT Filed: May 7, 2024
(86) PCT No.: PCT/EP2024/062612

§ 371 Date: Oct. 23, 2025

(30) Foreign Application Priority Data
May 10, 2023 (DE) 102023112297.5

(51) Int. Cl. F16K 31/04; F16K 31/50; F16K 31/53; F16K 37/00; G01L 5/00

(52) U.S. Cl. CPC F16K 31/047; F16K 31/50; F16K 31/53; F16K 37/0041; G01L 5/0057

(57) ABSTRACT

An actuator designed to actuate a fitting such as a valve, includes an output having a threaded spindle and a spindle nut. The output is resiliently mounted in the housing in an axial direction of the threaded spindle by a spring device. The output assumes a rest position in a force-free state. The actuator has a force measuring device to measure a force of the output against the spring device or to detect a force limit position. The spring device has at least one first spring element and at least one second spring element. The first spring element is designed to exert a force against a deflection of the output from the rest position in a first direction. The second spring element is designed to exert a force against a deflection of the output from the rest position in a second direction opposite the first direction.

### CROSS-REFERENCE TO RELATED APPLICATIONS

This application is a 371 National Phase of International Application No. PCT/EP 2024/062612, filed May 7, 2024, which claims priority from German Patent Application No. 10 2023 112 297.5, filed May 10, 2023, both of which are incorporated herein by reference as if fully set forth.

### TECHNICAL FIELD

The invention relates to an actuator for automation technology, in which an output has a linearly or axially moving element. For example, DE 21 2008 000 062 U1shows such an actuator.

### BACKGROUND

In the field of automation technology, it may be of interest to mount the output in a spring-loaded manner in order, for example, to be able to absorb and measure any axial forces that arise. However, the installation of such a spring-loaded mounting leads to an increase in the size of the actuator.

### SUMMARY

The object of the invention can be seen as proposing an actuator which has a compact design of the spring-loaded mounting and enables robust and reliable force measurement.

The object is solved by an actuator having one or more of the features disclose herein.

An actuator according to the invention for automation technology, designed to actuate a fitting such as a valve, comprises:
A housing having a housing wall;
An electric motor;
A gearbox;
An electronic operating circuit for operating the electric motor;
An output having a threaded spindle and a spindle nut, wherein the threaded spindle is fixed in rotation and is designed to actuate a fitting by means of an axial movement,
wherein the electric motor, gearbox, and electronic operating circuit are arranged in the housing,
wherein the electric motor is designed to drive the spindle nut rotatably by means of the gearbox and thereby move the threaded spindle axially,
wherein the output is resiliently mounted in the housing in an axial direction of the threaded spindle by means of a spring device,
wherein the output takes up a rest position in a force-free state,
wherein the actuator in particular has a force measuring device which is designed to measure a force of the output against the spring device or to detect a force limit position,
wherein the spring device comprises at least one first spring element and at least one second spring element,
wherein the at least one first spring element is designed to exert a force against a deflection of the output from the rest position in a first direction,
wherein the at least one second spring element is designed to exert a force against a deflection of the output from the rest position in a second direction opposite to the first direction.

In this way, a compact spring device can be set up.

In one design, the first spring element and the second spring element have different spring constants. In this way, a load on the output that depends on the direction of movement can be taken into account. For example, greater forces occur when a fitting is closed than when it is opened, so that different measuring ranges are required for force measurement depending on the direction of movement.

In one design, the at least one first spring element and the at least one second spring element surround the output, wherein a cross-sectional plane of the first spring element and a cross-sectional plane of the second spring element are spaced apart by less than 30%, and in particular less than 25%, and preferably less than 20% of a diameter of the first spring element or of the second spring element.

In this way, a spring device that is compact in the axial direction can be set up.

In one design, the spindle nut is mounted radially by means of a roller bearing, which roller bearing is at least partially arranged in a cylindrical recess in the housing wall,
wherein the cylindrical recess provides a stop for the roller bearing against movement in the direction of a side of the cylindrical recess facing away from the housing,
wherein the roller bearing contacts the stop when the output is in the rest position and/or is pretensioned against the stop,
wherein the at least one first spring element and the at least one second spring element act against the roller bearing on a side of the roller bearing facing the housing.

The support of the first spring element and the second spring element from one side against the roller bearing contributes to improved compactness of the spring device.

In one design, the actuator has a spring plate fixed in the housing with a central opening through which the spindle nut is guided,
wherein the spindle nut has a radial formation, in particular a collar, on a side of the spring plate facing away from the housing, which is designed to act directly or indirectly as a stop against the spring plate,
wherein the spring plate is designed as one of the at least one first spring elements.

In one design, the spring plate is arranged outside the cylindrical recess, wherein the radial formation acts against the spring plate via the roller bearing.

In one design, the gearbox has a first toothed element, such as a gearwheel, which is rotatably connected to the spindle nut,
wherein the spring device has at least one disc spring, which at least one disc spring surrounds the spindle nut and is designed as at least one of the at least one second spring element,
wherein the at least one disc spring is arranged and clamped between the first toothed element and the roller bearing.

In one design, the force measuring device is designed to convert a deflection of the output from the rest position against the spring device into a deflection-dependent measuring signal of an electronic measured variable such as inductance, capacitance, current or voltage,
wherein the force measuring device or the electronic operating circuit is designed to derive or calculate a measured value for the force from the measuring signal.

In one design, the force measuring device has a sensor for generating the measuring signal, such as a coil, a capacitor or a photodiode,
wherein the force measuring device has a sensing arm which is designed to be moved by an axial movement of the spindle nut and thereby to cause a change in the measuring signal of the electronic measured variable.

In one design, the force measuring device has a lever device with a lever bearing and a first end and an opposite second end relative to the lever bearing,
wherein the sensing arm forms the first end, wherein the second end is designed to influence a measured value of the electronic measured variable in a position-dependent manner,
wherein a lever length of the first end is in particular smaller than a lever length of the second end.

A smaller lever length of the first end allows a small deflection of the spring-mounted device to be translated into a larger change in the measuring signal.

In one design, the sensor has a sensor element with a front surface, wherein the second end is designed to at least partially cover the front surface, wherein a coverage ratio depends on the force against the spring device,
wherein the sensor element has a coil, wherein the second end is permanently magnetic and/or electrically conductive, wherein the second end is designed to influence an inductance of the coil and the second end,
or wherein the sensor element comprises a capacitor plate, wherein the second end is electrically conductive, wherein the second end is designed to influence a capacitance of the capacitor plate and the second end,
or wherein the sensor element is a photodiode, wherein the second end is designed to attenuate or block light incident, for example, from an LED.

In one design, the second end is disc-shaped.

In one design, measured values of the measuring signal assume a value range with a maximum value and a minimum value,
wherein a measured value of the measuring signal in the force-free state of the output takes a value which is less than 30%, and in particular less than 25%, and preferably less than 20% of a difference between a maximum value and a minimum value from a mean value of the value range.

In this way, a deflection of the spring-mounted device in both directions can be detected with sufficient detection clearance.

### BRIEF DESCRIPTION OF THE DRAWINGS

The invention is described below with reference to exemplary embodiments.

FIG. 1 shows a cross-section of an exemplary actuator according to the invention.

FIG. 2 shows an enlarged section of the actuator shown in FIG. 1.

FIGS. 3A and 3B outline sensors of an actuator according to the invention.

### DETAILED DESCRIPTION

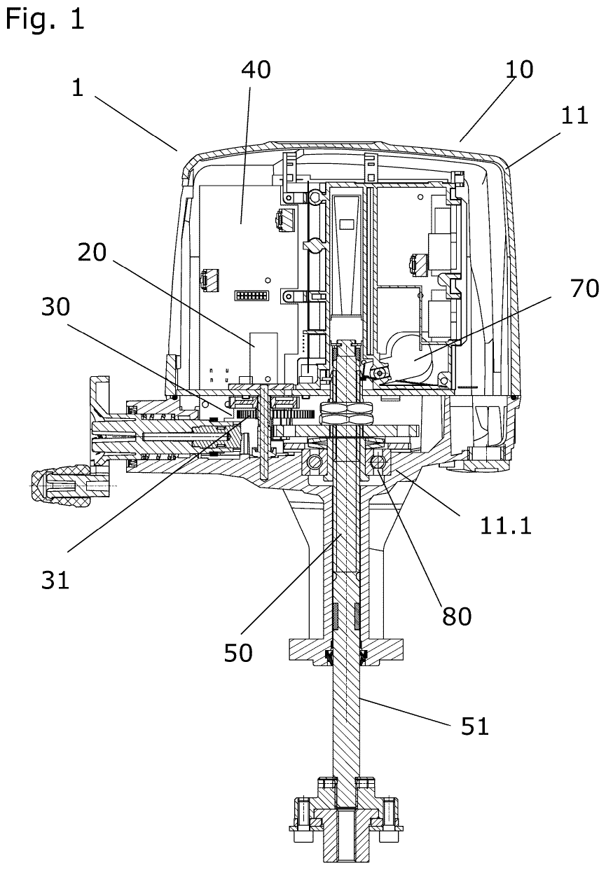

FIG. 1 shows a cross-section through an exemplary actuator 1 according to the invention, comprising a housing 10 with a housing wall 11, wherein an electric motor 20, an electronic operating circuit 40 for operating the electric motor, a gearbox 30, and an output 50 are arranged in the housing of the actuator. The output has a threaded spindle 51, wherein the output is designed to actuate a fitting by means of the rotary movement of the threaded spindle. The gearbox 50 is designed to transmit a force or torque from the electric motor to the output and has toothed parts 51, such as gearwheels 51.1 or worms, which are mounted on toothed part bearings 32, such as gear axles 32.1 or gear shafts 32.2. The electric motor is designed to move the output axially, wherein the output is spring-mounted by means of a spring device 60. The actuator has a force measuring device 70, which is designed to measure a mechanical force causing the movement of the output from a deflection of the spring-mounted device from a rest position. The electronic operating circuit can then derive a drive efficiency of the actuator, for example, from force measurement values relating to the output movement and from measured values of a mechanical motor force derived from the motor current and/or motor voltage.

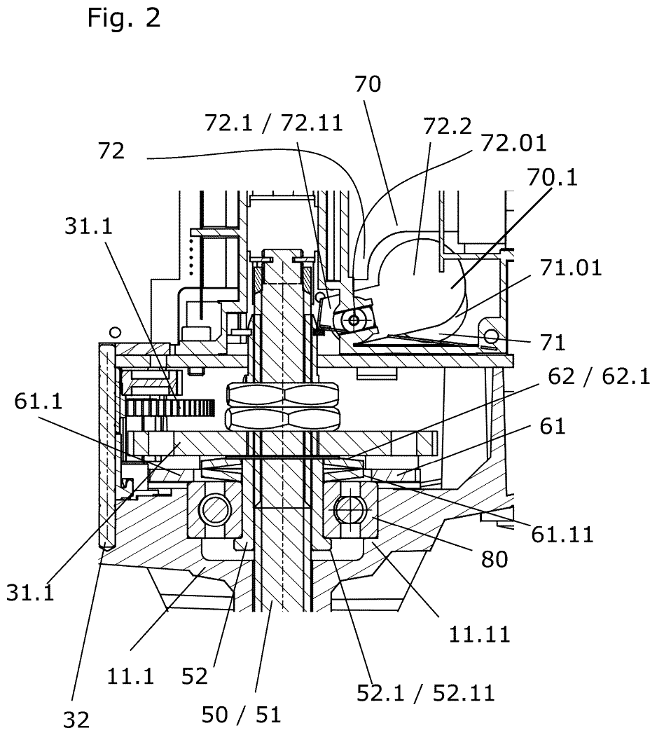

FIG. 2 shows a section of the cross-section of the actuator 1 shown in FIG. 1. The spring device has at least one first spring element 61 and at least one second spring element 62, wherein the at least one first spring element is designed to exert a force against a deflection of the output from the rest position in a first direction, wherein the at least one second spring element is designed to exert a force against a deflection of the output from the rest position in a second direction opposite to the first direction.

The spindle nut 52 can be mounted radially as shown here by means of a roller bearing 80, which roller bearing is arranged at least partially in a cylindrical recess 11.1 of the housing wall, wherein the cylindrical recess provides a stop 11.11 for the roller bearing against movement in the direction of a side of the cylindrical recess facing away from the housing, wherein the roller bearing contacts the stop when the output 40 is in the rest position and/or is pretensioned against the stop, wherein the at least one first spring element 61 and the at least one second spring element 62 act against the roller bearing on a side of the roller bearing facing the housing. The cylindrical recess provides a stop 11.11 for the roller bearing.

In one design, a spring plate 61.1 fixed in the housing has a central opening 61.11, through which opening the spindle nut 52 is guided, wherein the spindle nut has a radial formation 52.1, in particular a collar 52.11, on a side of the spring plate facing away from the housing which is designed to act directly or indirectly as a stop against the spring plate, wherein the spring plate is designed as one of the at least one first spring elements 61. The spring plate 61.1 is arranged outside the cylindrical recess 11.1, wherein the radial formation 52.1 acts against the spring plate via the roller bearing 80. One of the toothed elements 31 of the gearbox 30 is rotatably connected to the spindle nut 52.

In one design, the spring device 60 has at least one disc spring 62.1, which disc spring surrounds the spindle nut and is designed as at least one of the at least one second spring element 62, wherein the at least one disc spring is arranged and clamped between the first toothed element and the roller bearing. In this way, the spring device 60 can be implemented in a compact manner.

The force measuring device as shown here by way of example has the lever device 72 with a lever bearing 72.01 and, with respect to the lever bearing, a first end 72.1 and a second end 72.2, which is in particular opposite, wherein the sensing arm forms the first end, wherein the second end is designed to influence a measured value of the electronic measured variable in a position-dependent manner, wherein a lever length of the first end is in particular smaller than a lever length of the second end.

In one design, the force measuring device 70 of an exemplary actuator according to the invention is designed to convert a deflection of the spring-mounted device 61 from the rest position against the spring device 60 into a deflection-dependent measuring signal of an electronic measured variable such as inductance, capacitance, current or voltage, wherein the force measuring device or the electronic operating circuit 30 is designed to derive or calculate a measured value for the force from the measuring signal. A sensor 71 of the force measuring device is designed to generate a measuring signal corresponding to the propulsive force. The sensor may have a front surface 71.1, wherein the second end 72.2 is designed to cover the front surface at least partially, wherein a coverage ratio is dependent on the propulsive force against the spring device and influences the measuring signal.

Measured values of the measuring signal assume a value range with a maximum value and a minimum value, wherein, in one design, a measured value of the measuring signal in a force-free state of the output assumes a value which is less than 30%, and in particular less than 25%, and preferably less than 20% of a difference between the maximum value and the minimum value from a mean value of the value range. In this way, a deflection of the spring-mounted device in both directions can be detected with sufficient detection clearance.

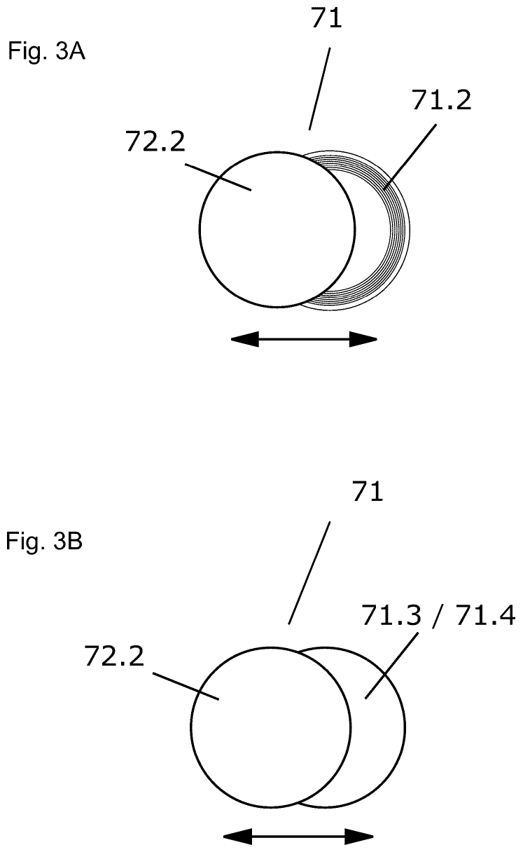

Sensor elements 71 are schematically outlined in FIGS. 3A and 3B. As shown in FIG. 3A, the sensor element may comprise a coil 71.2, the second end of which is permanently magnetic and/or electrically conductive, the second end being designed to influence an inductance of the coil and the second end.

The sensor element may comprise a capacitor plate 71.3, as shown in FIG. 3b), wherein the second end is electrically conductive, wherein the second end is arranged to influence a capacitance of the capacitor plate and the second end. Alternatively, the sensor may comprise a photodiode 71.4, wherein the second end is designed to attenuate or block light incident thereon, for example generated by an LED.

The invention is not limited to the exemplary embodiments shown in FIGS. 1, 2, and 3; features of the exemplary embodiments may be exchanged with one another as technically appropriate.

### LIST OF REFERENCE SIGNS

1 Actuator
10 Housing
11 Housing wall
11.1 Cylindrical recess
11.1 Stop
20 Electric motor
30 Gearbox
31 Toothed element
31.1 Gearwheel
40 Electronic operating circuit
50 Output
51 Threaded spindle
52 Spindle nut
52.1 Radial formation
52.11 Collar
60 Spring device
61 First spring element
61.1 Spring plate
61.11 Central opening
62 Second spring element
62.1 Disc spring
70 Force measuring device
70.1 Sensor
71 Sensor element
71.0 Front surface
71.1 Coil
71.2 Capacitor or capacitor plate
71.3 Photodiode
72 Lever device
72.0 Lever bearing
72.1 First end
72.1 Sensing arm
72.2 Second end
80 Roller bearing

1. An actuator (1) for automation technology, configured to actuate a fitting the actuator comprising:
a housing (10) having a housing wall (11);
an electric motor (20);
a gearbox (30);
an electronic operating circuit (40) for operating the electric motor;
an output (50) having a threaded spindle (51) and a spindle nut (52), wherein the threaded spindle is fixed in rotation and is designed to actuate a fitting by an axial movement,
wherein the electric motor, the gearbox, and the electronic operating circuit are arranged in the housing,
wherein the electric motor is adapted to drive the spindle nut rotatably via the gearbox and thereby move the threaded spindle axially,
wherein the output is resiliently mounted in the housing in an axial direction of the threaded spindle by a spring device (60),
wherein the output assumes a rest position in a force-free state,
a force measuring device (70) which is adapted to measure a force of the output against the spring device (60) or to detect a force limit position,
the spring device comprises at least one first spring element (61) and at least one second spring element (62),
the at least one first spring element is adapted to exert a force against a deflection of the output from the rest position in a first direction, and
the at least one second spring element is adapted to exert a force against a deflection of the output from the rest position into a second direction opposite to the first direction.

2. The actuator according to claim 1,
wherein the at least one first spring element (61) and the at least one second spring element (62) surround the output (50), a cross-sectional plane of the first spring element and a cross-sectional plane of the second spring element are spaced apart by less than 30% of a diameter of the first spring element (61) or of the second spring element (62).

3. The actuator according to claim 1,
wherein the spindle nut (52) is mounted radially by a roller bearing (80) that is at least partially arranged in a cylindrical recess (11.1) of the housing wall,
the cylindrical recess provides a stop for the roller bearing against movement in a direction of a side of the cylindrical recess facing away from the housing,
the roller bearing contacts the stop when the output is in the rest position and/or is pretensioned against the stop, and
wherein the at least one first spring element (61) and the at least one second spring element (62) act against the roller bearing on a side of the roller bearing facing the housing.

4. The actuator Actuator according to claim 3,
wherein the actuator has a spring plate (61.1) fixed in the housing (11) with a central opening (61.11) through which the spindle nut (52) is guided,
the spindle nut has a radial formation (52.1) on a side of the spring plate facing away from the housing, which is adapted to act directly or indirectly as a stop against the spring plate, and
the spring plate forms one of the at least one first spring elements (61).

5. The actuator according to claim 4, wherein the spring plate (61.1) is arranged outside the cylindrical recess (11.1), and the radial formation (52.1) acts against the spring plate via the roller bearing.

6. The actuator Actuator according to claim 1,
wherein the gearbox (30) has a first toothed element (31) which is rotatably connected to the spindle nut (52),
wherein the spring device (60) has at least one disc spring (62.1) that surrounds the spindle nut (52) and forms at least one of the at least one second spring element (62), and
the at least one disc spring is arranged and clamped between the first toothed element and the roller bearing.

7. The actuator Actuator according to claim 1,
wherein the force measuring device (70) is adapted to convert a deflection of the output from the rest position against the spring device into a deflection-dependent measuring signal of an electronic measured variable, and
the force measuring device or the electronic operating circuit (40) is configured to derive or calculate a measured value for the force from the measuring signal.

8. The actuator according to claim 7,
wherein the force measuring device (70) has a sensor (70.1) with a sensor element (71) for generating the measuring signal, and
wherein the force measuring device has a sensing arm (72.11) which is adapted to be moved by an axial movement of the spindle nut (52) and thereby to cause a change in the measuring signal of the electronic measured variable.

9. The actuator according to claim 8,
wherein the force measuring device has a lever device (72) with a lever bearing (72.01) and a first end (72.1) and a second end (72.2),
the sensing arm (72.11) forms the first end, and the second end is adapted to influence a measured value of the electronic measured variable in a position-dependent manner, and
lever length of the first end is smaller than a lever length of the second end.

10. The actuator according to claim 9,
wherein the sensor element (71) has a front surface (71.01), the second end (72.2) at least partially covers the front surface, wherein a coverage portion depends on the force against the spring device,
the sensor has a coil (71.1), the second end is permanently magnetic and/or electrically conductive, and the second end is adapted to influence an inductance of the coil and the second end,
or the sensor comprises a capacitor plate (71.2), the second end is electrically conductive, and the second end is adapted to influence a capacitance of the capacitor plate and the second end,
or the sensor is a photodiode (71.3), and the second end is adapted to attenuate or block light incident.

11. The actuator according to claim 10,
wherein the second end (72.2) is disc-shaped.

12. The actuator according to claim 10,
wherein measured values of the measuring signal assume a value range with a maximum value and a minimum value, and
a measured value of the measuring signal in the force-free state of the output takes a value which is less than 30% of a difference between the maximum value and the minimum value from a mean value of the value range.
